(19) United States
(12) Patent Application Publication
(10) Pub. No.: US 2006/0054130 A1
(43) Pub. Date: Mar. 16, 2006

(54) Mixture formation and combustion method for heat engine with direct fuel injection

(76) Inventor: Cornel Stan, Aue (DE)

Correspondence Address: LERNER GREENBERG STEMER LLP, P O BOX 2480, HOLLYWOOD, FL, 33022-2480, US

(21) Appl. No.: 10/485,753

(22) PCT Filed: Aug. 1, 2002
(86) PCT No.: PCT/DE02/02823

§ 371 Date: Feb. 26, 2004

(30) Foreign Application Priority Data
Aug. 2, 2001 (DE) 10137469.0

(51) Int. Cl. F02B 3/00

(52) U.S. Cl. 123/299

(57) ABSTRACT

The aim of the invention is to optimize the fuel distribution within the combustion air and to avoid the formation of liquid fuel nuclei. Direct fuel injection using two or more injector nozzles per combustion chamber is used in heat engines, such that the fuel envelopes are partly or completely formed by each injection nozzle such as to overlap each other from opposing directions. The mixture formation is influenced by the selection of a determined angle and the arrangement of the symmetry axis. Preferred applications are single- and multi-cylinder petrol and diesel engines with direct injection of conventional and alternative fuels with multi-orifice nozzles and pintle nozzles.

The invention relates to a mixture formation and combustion method for heat engines with direct fuel injection by means of two or more injection nozzles for each combustion space, with the aid of which fuel jets with a conical fuel surface are formed, the combustion space being delimited by a predominantly unprofiled head of the piston. The invention relates, furthermore, to a device for carrying out the method.

Preferred fields of use are single-cylinder and multicylinder gasoline and diesel engines with direct injection of conventional and alternative fuels by means of multihole nozzles and pintle nozzles.

Piston engines with direct fuel injection by the gasoline and diesel method are equipped predominantly with one injection nozzle for each cylinder.

In gasoline engines with direct injection, in general, the aim is to have a homogeneous air/fuel mixture for full-load operation or mixture formation for part-load operation.

An essential requirement to be met by the injection system is the sufficient atomization of the fuel, with the result that sufficient homogenization of the air/fuel mixture takes place in the entire combustion space—in the case of full load—or in one stratum—in the case of part load—and, as a result, combustion is as complete as possible, with only a slight delay. Fuel atomization necessitates small throughflow cross sections through the injection nozzle.

In order to inject the necessary injection quantity in a predetermined duration, for this purpose, in the technical solutions known hitherto, the fuel outlet velocity is set correspondingly high, this being implemented in most methods by means of a high injection pressure.

However, in general, a high drop velocity leads to a corresponding increase in the jet length. The combustion spaces of modern piston engines, however, are highly compact. This leads, in a method illustrated, to the disadvantage of a highly probable jet impingement on one of the combustion space walls, with the result that the formation of liquid cores, a local lack of oxygen or reactions occur on the relatively cold combustion space wall, thus causing incomplete combustion with an increased hydrocarbon emission.

In this context, drop size and jet length are partially contradictory. According to some known methods, the jet length is partially compensated by means of tumbling movements of the injected fuel about the flow axis.

In the solutions known hitherto, sufficient mixing or controlled charged stratification is carried out with the assistance of the fuel jet itself or of the airflow in the cylinder and of the combustion space configuration.

The methods known hitherto are therefore generally divided into wall-controlled, air-controlled and jet-controlled combustion methods.

In wall-controlled methods, the injection nozzle and the spark plug are mounted at a relatively considerable distance from one another. The injected fuel is in this case conducted to the spark plug by means of a combustion space recess, a scavenging air movement (tumble) controlled by inlet ducts and combustion space geometry having an assisting effect.

Jet deflection by means of a combustion space recess, which is partially assisted by the air movement, allows relatively tolerance-insensitive mixture formation.

The fundamental disadvantage of such a solution is the relatively high hydrocarbon emission which is brought about by wall fuel build-up.

The jet-controlled methods do not have this basic disadvantage, but the control of mixture formation is much more complex and more tolerance-sensitive: the jet velocity and jet length must in this case be adapted to each load situation, for which purpose a complicated adaption of the injection profile becomes necessary.

The air-controlled methods require an intensive and easily controllable tumbling movement of the scavenging air during mixture formation in the combustion space. As a result, basically, the wall build-up of the fuel or the modulation of the injection profile under high injection pressure can be seen in relative terms. However, the usual flow conditions during charge exchange allow a somewhat low flow intensity which cannot act as the sole medium for mixture formation.

In more recent known methods, therefore, all three approaches described are combined pro rata, the air tumble being implemented as forward tumble or as reverse tumble between the inlet ducts modified for this purpose and the specially shaped piston head. Such combined methods are more efficient for internal mixture formation than individual media, but they cannot avoid some fundamental disadvantages of the wall-controlled, air-controlled and jet-controlled methods: modern piston engines for vehicles have relatively high rotational speeds on account of the required high power related to cubic capacity. In order to keep the friction between piston and cylinder within the permissible range, the stroke/bore ratio is reduced for this purpose. With a given compression ratio and working volume, in this case, the piston diameter increases and the distance between piston and cylinder head at top dead center decreases.

This affords an extremely unfavorable basis for the combustion space configuration, in which an impingement of the fuel jet on a combustion space wall cannot be avoided.

In view of the necessary injection volume, on the one hand, and of the small throughflow cross sections and the short injection duration, on the other hand, a high outlet velocity and consequently a defined jet length, even in the case of the formation of a tumble about the flow axis, are unavoidable.

Furthermore, narrow limits are placed on the formation of a piston recess, which is necessary in virtually all the methods described. The additional combustion space volume occurring as a result leads either to the lowering of the compression ratio or to the further reduction in the gap dimension between piston and cylinder head. The approach in any case has these disadvantages because of the valve pockets which are generally present.

In diesel engines with direct injection, the relations described are basically similar, regardless of the fact that charge stratification is not required under part load. Although the higher temperature level in the combustion space and the higher pressure in the injection system are appreciably conducive to fuel atomization and evaporation, the jet contact with the piston surface is unfavorable for the combustion process.

To overcome these defects mentioned, EP 1 088971 A discloses a method whereby a spatially compact mixture cloud occurs at least when the injection jets of two injection nozzles meet one another. The substantial disadvantage of the meeting of injection jets in the way disclosed is that the fuel drops collide with one another. To that extent, the described effect with a view to a formation of the compact mixture cloud, although correct, is in no way advantageous, because the core of this compact mixture cloud lacks the combustion air.

Moreover, as is known, the collision of injection jets leads to the formation of larger drops or to a high fuel concentration at the meeting points. As a result of this, too, the mixture cloud which occurs can scarcely come into contact with any additional combustion air. Large drops, on the one hand, and high fuel concentrations on the other hand, lead unequivably to incomplete combustion, even though the meeting of the two injection jets, on the one hand, avoids contact with combustion space surfaces and, on the other hand, gives rise to a mixture cloud at the desired point, for example in front of a spark plug.

Likewise known technical solution according to EP 10176628 A has just the same disadvantages, in this case the proposed horizontal arrangement of the injection jet axes along a single line further reinforcing the collision effect described above.

The object of the invention is, therefore, to overcome the disadvantages of the known prior art. The aim is a technical solution which, at a relatively low outlay in control terms and largely without combustion space adaption, affords preconditions for sufficient fuel distribution to the air in a controllable region of the combustion space, as far as possible without fuel contact with a combustion space wall for any load/rotational speed combination.

The technical solution to be developed is to optimize the fuel distribution in the combustion air and to avoid the formation of liquid fuel cores. This mixture formation is to be capable of being carried out as far as possible without fuel contact with the combustion space wall in a selectable region of the combustion space. Furthermore, the solution aimed at is to make it possible to ensure the intimate formation of the fuel/air mixtures, with the avoidance of appreciable fuel contacts with a combustion space wall, as far as possible for any practically relevant load/rotational speed combination.

The object is achieved, according to the invention, by means of the protected features of claims 1 to 22.

The mixture formation and combustion method for heat engines with direct fuel injection is in this case characterized in that essentially two or more injection nozzles are provided for each combustion space, which are preferably designed as multihole nozzles or pintle nozzles, the fuel envelope area formed partially or completely by each nozzle penetrating the surface areas of the further nozzles at a defined angle and with a defined assignment of the axis of symmetry. With an unchanged throughflow cross section of a nozzle, the atomization quality remains unchanged.

However, the increase in the number of nozzles for each combustion space brings about an increase in the overall throughflow cross section. At the same time, for a predetermined injection quantity, both the outlet velocity and consequently fuel envelope areas of two or more nozzles are combined in a projection inside or outside the combustion space. This gives rise to a meeting of the hollow cones in the combustion space, the fuel drops of the threads or of the surfaces of different hollow cones meeting on elliptical lines and forming a fuel envelope, that is to say the fuel concentration increases in this region. This gives rise to a fuel surface closed on itself, consisting of shells with different shapes which enclose an air core at their center.

The meeting of the fuel jets from different nozzles brings about a marked deceleration of the drop velocity, with the result that the impingement of a jet on a combustion space wall is essentially prevented.

Due to the formation of hollow cones by the fuel jets and to the linear contact of the hollow cones, the impingement of the fuel jets onto the combustion space wall is largely avoided, the formation of liquid fuel cores is ruled out and the formation of a stable air core is implemented.

In particular embodiments, the method is characterized in that the fuel surface closed on itself and having an air core is formed by the impingement angle of the axis of symmetry of two or more nozzles in a defined zone of the combustion space, preferably in the vicinity of the spark plug in the case of a gasoline engine and in the middle of the combustion space in the case of a diesel engine.

In this instance, when the method is applied to gasoline engines, because charge stratification is implemented, air throttling devices may be dispensed with or the regulation of the air supply may take place largely independently of the regulation of the fuel supply, since, outside the fuel envelope, an airspace is formed which does not directly influence the combustion of the fuel. A variable air ratio is consequently provided in the remaining combustion space outside the fuel envelope.

The fuel surface closed on itself and having an air core remains in the same position in the combustion space, even in the event of a change in the jet length which may occur due to a variation in the injection quantity. On the other hand, this position is scarcely capable of being influenced by the airflow. The position of the fuel surface which has arisen is therefore largely dependent on load and on rotational speed.

Furthermore, it is possible, depending on the conditions prevailing the combustion space, for the hollow cone angles of the impinging jets to be different by virtue of a corresponding nozzle design.

It is possible, furthermore, for the resulting fuel surface to come about as a result of a combined use of multihole and pintle nozzles.

In a particular version of the method, the axis of symmetry of the flows from two nozzles in each case are located in different planes, for example in parallel planes, in a combustion space.

Owing to the preferably insignificant axial offset, furthermore, the probability of the collision of drops of different flows is reduced. A movement of the fuel on the surface formed arises in this case and, furthermore, is conducive to mixture formation.

It is possible, moreover, to use both externally controlled injection nozzles, for example electromagnetically or mechanically controlled, and fuel-controlled injection nozzles. In the latter instance, which presupposes high-pressure modulation at the inlet of each nozzle, the nozzles have a particularly compact and relatively simple construction, this being advantageous with regard to space requirement and outlay.

In a particular version of the method, the fuel outflow from each nozzle is characterized, before the impingement of the jets, by a tumble about the specific axis of symmetry. This gives rise both to a more complex shape of the resulting closed fuel surface having an air core and to a defined velocity distribution of the fuel on this surface. Mixture formation and combustion are further assisted thereby.

Furthermore, it is possible that even different fuels, for example gasoline and methanol for gasoline engines, are injected through the different nozzles in a combustion space.

The invention is explained in more detail below with reference to an exemplary embodiment.

In the accompanying drawings:

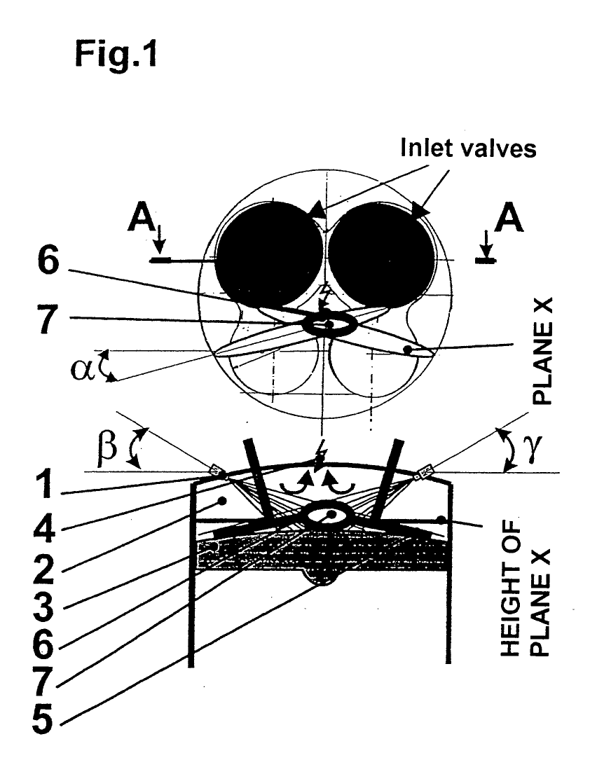

FIG. 1: shows a diagrammatic illustration of the combustion space of a piston engine with two injection nozzles, the axis of symmetry of the nozzles being located in the same vertical axis, along the cylinder axis;

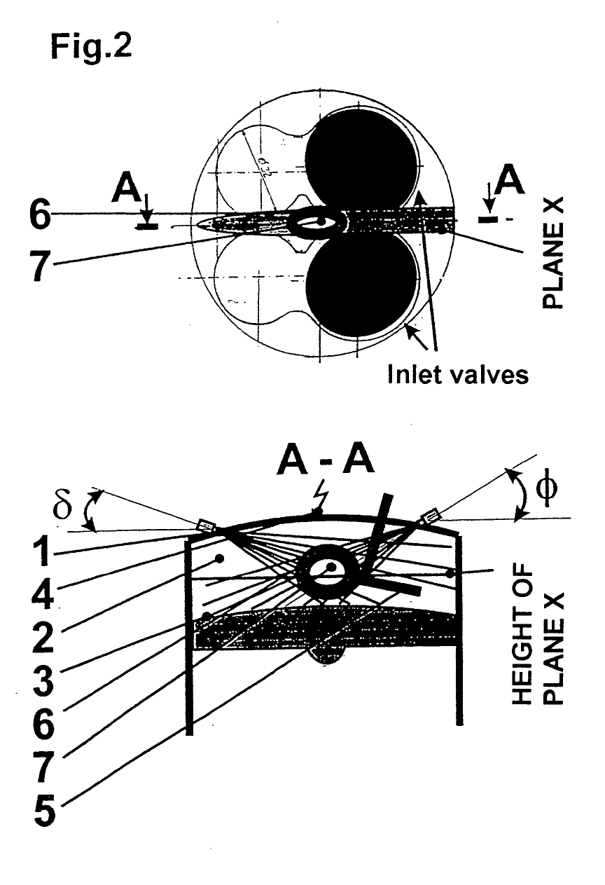

FIG. 2: shows a diagrammatic illustration of the combustion space of a piston engine with two injection nozzles, the axis of symmetry of the nozzles having an angle in vertical and horizontal projection;

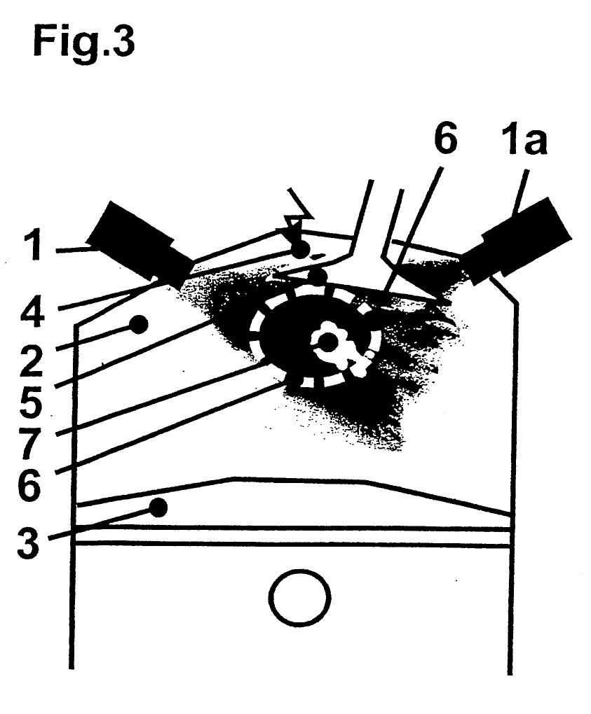

FIG. 3: shows a closed fuel surface having an air core in a combustion space as a result of the meeting of two injection jets;

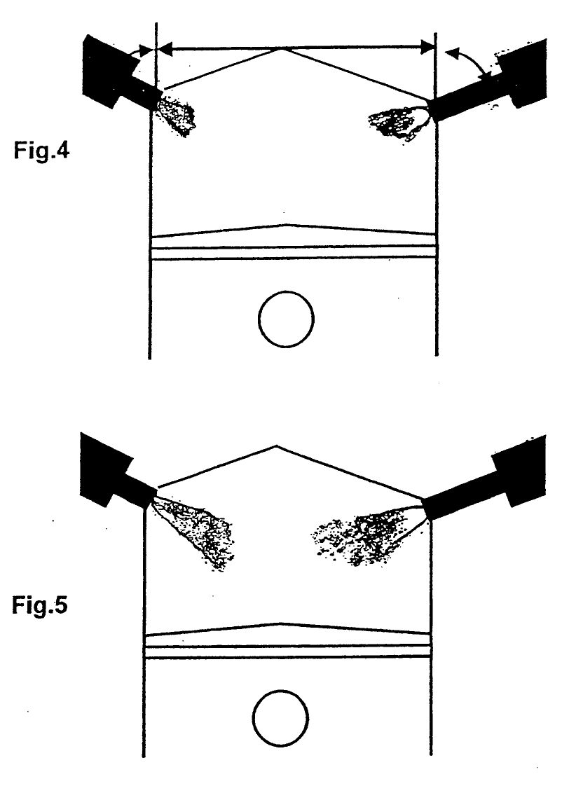

FIG. 4: shows an illustration of the formation of the hollow-conical fuel jets 0.28 ms after the start of injection;

FIG. 5: shows an illustration of the formation of the hollow-conical fuel jets 0.56 ms after the start of the injection;

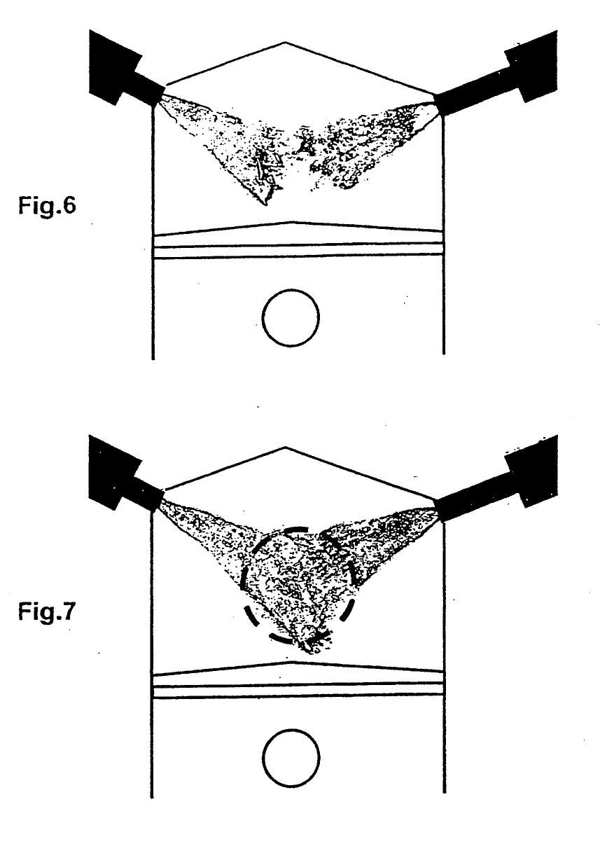

FIG. 6: shows an illustration of the formation of the hollow-conical fuel jets 0.83 ms after the start of the injection;

FIG. 7: shows an illustration of the meeting of two hollow-conical fuel jets 1.11 ms after the start of injection;

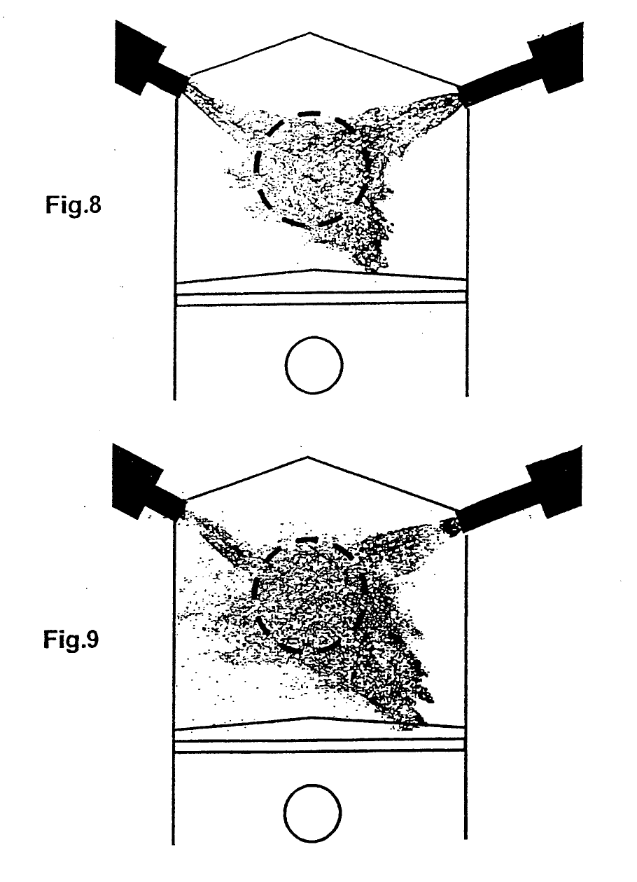

FIG. 8: shows an illustration of the meeting of two hollow-conical fuel jets 1.38 ms after the start of the injection, with the formation of the fuel envelope and the enclosed air core;

FIG. 9: shows an illustration of the meeting of two hollow-conical fuel jets 1.66 ms after the start of injection, for the formation of a fuel envelope and the enclosed air core.

### EXEMPLARY EMBODIMENT

As is evident from FIGS. 1 to 9, a closed fuel envelope 6 with an air core 6 enclosed by the latter is prepared for the combustion space 2 of a multicylinder gasoline engine, in that the fuel is injected directly into the combustion space through two injection nozzles 1 and 1a, the axis of symmetry of the flows of the two injection nozzles having different angles and meeting at a point. As a result, according to FIGS. 7-9, the fuel envelope areas from the two nozzles impede one on to the other approximately in the middle of the combustion space. Owing to the fact that the fuel envelope area of each nozzle is designed as a hollow cone, this intersection of the two flows produces a fuel surface which is closed on itself and which, as a fuel envelope 6, encloses an air core 7. The fuel surface of the fuel envelope 6 is located at a point in the immediate vicinity of the spark plug 4.

As a result of the thin fuel surface or of the enclosed air core, a deformation of the fuel cloud 6 takes place during the upward movement of the piston 5, with the result that an impingement of fuel onto the piston is largely avoided.

As illustrated in FIG. 2, the injection nozzles may be placed in such a way that the axis of symmetry of the flows have different angles in horizontal and vertical projection.

By a suitable combination of the jet angles and of the axial position of each nozzle, it is possible, even with the inlet valves open, to inject the fuel without any direct contact of the injection jet with a valve. Such a prolongation of the mixture formation duration into the charge exchange phase is advantageous particularly in the case of direct injection in engines with an especially high rotational speed.

### LIST OF REFERENCE SYMBOLS

1—Injection nozzle
1a—Injection nozzle
2—Combustion space
3—Piston
4—Spark plug
5—Inlet valve
6—Fuel envelope
7—Air core

1. A mixture formation and combustion method for heat engines with direct fuel injection into the combustion space (2) by the use of fuel injection nozzles (1), with the aid of which fuel jets having a conical fuel surface (6) are formed, the combustion space (2) being delimited by a predominantly unprofiled head of the piston (3), characterized in that, by means of axis, arranged at an angle to one another, of at least two injection nozzles (1, 1a), the hollow-conical fuel jets penetrate one another within the combustion space (2), and in that, in a structurally selectable region of the combustion space (2), at least one air core (7) enclosed by a fuel envelope (6) is formed by the partially interpenetrating hollow cone jets of the fuel injection nozzle (1, 1a).

2. The mixture formation and combustion method as claimed in claim 1, characterized in that the hollow cone angles formed by the individual fuel injection nozzles (1, 1a) are dimensioned differently.

3. The mixture formation and combustion method as claimed in one of claims 1, characterized in that the projection planes formed by the axis of the fuel injection nozzle (1, 1a) in the combustion space (2) are set parallel to or at an angle to one another.

4. The mixture formation and combustion method as claimed in one of claims 1, characterized in that the fuel injection nozzles (1, 1a) used are controlled mechanically or electromagnetically.

5. The mixture formation and combustion method as claimed in one of claims 1, characterized in that the fuel injection nozzles (1, 1a) used are controlled by the fuel itself by means of a direct injection system having high-pressure modulation at the inlet of the injection nozzles (1, 1a).

6. The mixture formation and combustion method as claimed in one of claims 1, characterized in that one or more hollow-conical fuel jets are injected into the combustion space (2) in a tumbling manner about the specific flow axis.

7. The mixture formation and combustion method as claimed in one of claims 1, characterized in that different fuels are injected into the combustion space (2) by individual fuel injection nozzles (1, 1a).

8. The mixture formation and combustion method as claimed in one of claims 1, characterized in that the fuels used are liquid or gaseous media.

9. The mixture formation and combustion method as claimed in one of claims 1, characterized in that the ignition of the fuel/air mixture is carried out by autoignition or by means of the spark plugs (4).

10. The mixture formation and combustion method as claimed in one of claims 1, characterized in that the formation of a fuel surface (6) closed on itself is carried out by means of interpenetrating hollow cone jets with enclosed air core (7) into the combustion spaces (2) of reciprocating-piston, rotary-piston or turbomachines.

11. The mixture formation and combustion method as claimed in one of claims 1, characterized in that the fuel injection nozzles (1, 1a) used are multihole and/or pintle nozzles.

12. A device for carrying out the method as claimed in one of claims 1, consisting of a combustion space (2) with a fuel injection nozzle (1), characterized in that two fuel injection nozzles (1, 1a) are arranged, in that the flow axis of the fuel injection nozzles (1, 1a) are arranged at an angle to one another, and in that the intersection point of the flow axis of at least two fuel injection nozzles (1, 1a) is arranged inside or outside the combustion space (2).

13. The device for carrying out the method as claimed in claim 12, characterized in that the fuel injection nozzles (1, 1a) are designed as multihole or pintle nozzles forming hollow-conical surface areas.

14. The device for carrying out the method as claimed in claims 12, characterized in that the projection planes formed perpendicularly to the head of the piston (3) of a reciprocating-piston engine by means of at least two fuel injection nozzles (1, 1a) are arranged at an angle to one another.

15. The device for carrying out the method as claimed in claims 12, characterized in that the projection planes formed perpendicularly to the head of the piston (3) of a reciprocating-piston engine by means of at least two fuel nozzles (1, 1a) are arranged parallel to one another.

16. The device for carrying out the method as claimed in claims 12, characterized in that the projection planes formed perpendicularly to the head of the piston (3) of a reciprocating-piston engine by means of at least two fuel injection nozzles (1, 1a) are arranged in a common plane.

17. The device for carrying out the method as claimed in claims 12, characterized in that, in the case of a gasoline engine, the center of gravity of the air core (7) enveloped by a closed fuel envelope (6) formed by the hollow-conical fuel jets is arranged in the vicinity of the ignition point.

18. The device for carrying out the method as claimed in claims 12, characterized in that, in the case of a gasoline engine, owing to the formation of the fuel envelope (6) having an enclosed air core (7) as a result of charge stratification, work can be carried out without devices for regulating the air supply.

19. The device for carrying out the method as claimed in claims 12, characterized in that, in the case of a gasoline engine, the devices for regulating the air supply are designed to work in a manner largely decoupled from the devices for regulating the fuel supply quantity.

20. The device for carrying out the method as claimed in claims 12, characterized in that tumble elements are used in the fuel injection nozzles (1, 1a).

21. The device for carrying out the method as claimed in claims 12, characterized in that the fuel injection nozzles (1, 1a) are connected to electromagnetic or mechanical control elements.

22. The device for carrying out the method as claimed in claims 12, characterized in that the fuel injection nozzles (1, 1a) are connected to a high-pressure modulation element for pressure-dependent nozzle control.
